(19) United States
(12) Patent Application Publication
(10) Pub. No.: US 2013/0021543 A1
(43) Pub. Date: Jan. 24, 2013

(54) PHOTOSENSITIVE RESIN COMPOSITION AND APPLICATION THEREOF

(71) Applicants: Chih-Hung LIN, Tainan City (TW); Chia-Hui YU, Puzih City (TW)

(72) Inventors: Chih-Hung LIN, Tainan City (TW); Chia-Hui YU, Puzih City (TW)

(73) Assignee: CHI MEI CORPORATION, Tainan City (TW)

(21) Appl. No.: 13/546,116

(22) Filed: Jul. 11, 2012

(30) Foreign Application Priority Data
Jul. 20, 2011 (TW) 100125653

(51) Int. Cl. C08L 47/00; G02F 1/1333; C08F 236/20

(52) U.S. Cl. 349/12; 522/42; 522/64; 525/208; 525/223; 525/227

(57) ABSTRACT

A photosensitive resin composition includes: a copolymer obtained by subjecting a conjugated diene polymer having a (meth)acryloyl group, a conjugated diene monomer, and a (meth)acrylic acid monomer to copolymerization; a compound having at least one ethylenically unsaturated group; and a photoinitiator. The copolymer contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

### CROSS-REFERENCE TO RELATED APPLICATION

This application claims priority of Taiwanese Application No. 100125653, filed on Jul. 20, 2011.

### BACKGROUND OF THE INVENTION

1. Field of the Invention

This invention relates to a photosensitive resin composition, more particularly to a photosensitive resin composition having high adhesion property and good impact resistance. This invention also relates to an adhesive layer formed from the photosensitive resin composition and a display device containing the adhesive layer.

2. Description of the Related Art

An image display device generally includes a display unit and a transparent panel, such as a protective panel or a touch panel, disposed above the display unit. There is a gap which is defined between the display unit and the transparent panel, and which generally contains air. Since the refraction index of air is different from that of the transparent panel, a reflection phenomenon will be produced, which results in reduction of light transmission.

In order to solve the aforesaid problem, it has been proposed to fill the gap between the display unit and the transparent panel with a resin composition so that the display unit and the transparent panel can be firmly adhered to each other and that a buffer effect can be provided by the resin composition when a stress is imposed on the transparent panel. Therefore, in addition to transparency and adhesion properties, the resin composition should have proper characteristics, such mechanical properties, optical properties, or the like, specified for the display unit and the transparent panel.

The resin composition is generally classified into a thermal-curable type of resin composition, a photo-curable type of resin composition, and a photo-thermal curable type of resin composition. Some of the display units (for example, an electroluminescent device) have a heat distortion temperature ranging from about 80-120° C., and the thermal resistance thereof is insufficient. The display unit may be damaged when curing the thermal-curable type of resin composition via a heating process. Therefore, the photo-curable type of resin composition is more useful as compared to the thermal-curable type of resin composition.

Japanese patent publication No. 2009-186963 discloses a resin composition which includes a polymer, a monomer, and a photopolymerization initiator. The polymer is selected from polyurethane acrylate, a hydrogenated terpene resin, a butadiene polymer, and polyisoprene acrylate or an ester thereof. The monomer is an acrylate monomer selected from isobornyl acrylate and 2-hydroxy-butyl methacrylate. The photopolymerization initiator is selected from 1-hydroxycyclohexyl phenyl ketone and diphenyl-(2,4,6-trimethylbenzoyl)phosphine oxide. The polymer included in the resin composition contains about 30 wt % of a polymer fraction having a molecular weight ranging from 30,000 to 900,000 and about 40 wt % of a polymer fraction having a molecular weight ranging from 1,000 to 10,000. It is found by the inventors that the adhesion property and the impact resistance of the resin composition are insufficient when the composition is used in an image display device.

It is still required in the art to provide a photosensitive resin composition which can be used to form an adhesive layer having superior adhesion property, mechanical property (especially, impact resistance), and optical property.

### SUMMARY OF THE INVENTION

Therefore, an object of the present invention is to provide a photosensitive resin composition which is superior in adhesion property and impact resistance when used to form an adhesive layer in a display device.

According to a first aspect of this invention, there is provided a photosensitive resin including: a copolymer obtained by subjecting a conjugated diene polymer having a (meth)acryloyl group, a conjugated diene monomer, and a (meth)acrylic acid monomer to copolymerization; a compound having at least one ethylenically unsaturated group; and a photoinitiator. The copolymer contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

According to a second aspect of this invention, there is provided an adhesive layer which is adapted to be formed in a display device. The adhesive layer is formed by curing the photosensitive resin composition of this invention.

According to a third aspect of this invention, there is provided a display device including a touch unit, a liquid crystal display unit, and the adhesive layer disposed between the touch unit and the liquid crystal display unit.

According to a fourth aspect of this invention, there is provided a process for producing a copolymer for a photosensitive resin composition including a step of: subjecting a conjugated diene polymer having a (meth)acryloyl group, a conjugated diene monomer, and a (meth)acrylic acid monomer to copolymerization so that the copolymer thus produced contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

### DETAILED DESCRIPTION OF THE PREFERRED EMBODIMENTS

As used herein, the term “(meth)acrylate” means acrylate and/or methacrylate.

The photosensitive resin composition of the present invention includes: (A) a copolymer obtained by subjecting a conjugated diene polymer having a (meth)acryloyl group, a conjugated diene monomer, and a (meth)acrylic acid monomer to copolymerization; (B) a compound having at least one ethylenically unsaturated group; and (C) a photoinitiator. The copolymer contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

(A) Copolymer obtained by subjecting a conjugated diene polymer having a (meth)acryloyl group, a conjugated diene monomer, and a (meth)acrylic acid monomer to copolymerization:

The copolymer (A) is preferably prepared by a process including following steps:

(a) A conjugated diene monomer is dissolved in a solvent. An anionic polymerization is conducted using sec-butyl lithium as an initiator to obtain a conjugated diene polymer.

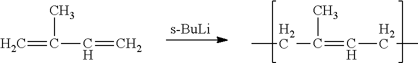

(b) The conjugated diene polymer thus obtained and maleic anhydride are mixed in a solvent. Polymerization is conducted at a temperature ranging from 85° C. to 100° C. so as to graft maleic anhydride onto the conjugated diene polymer. A maleic-anhydride-modified conjugated diene polymer is obtained accordingly.

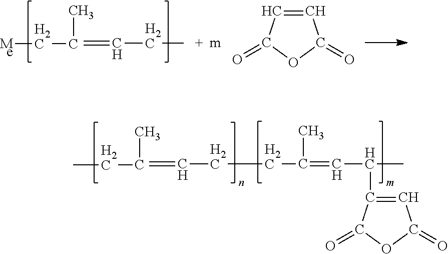

(c) The maleic-anhydride-modified conjugated diene polymer thus obtained is mixed with a (meth)acrylic acid monomer containing a hydroxyl group in a solvent, and a half-esterification reaction is performed by adding hydroquinone and N,N-dimethylbenzylamine as catalysts to obtain a conjugated diene polymer containing a (meth)acryloyl group shown as formula (a).

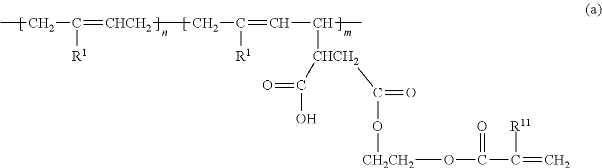

R¹ and R¹¹ in formula (a) independently represent hydrogen or methyl, n is an integer ranging from 1 to 20,000, and m is an integer ranging from 1 to 4,000.

(d) The conjugated diene polymer of formula (a) is mixed into a solvent, followed by heating to a reaction temperature. An effective amount of a conjugated diene monomer, an effective amount of a (meth)acrylic acid monomer, and an initiator are added so that the conjugated diene monomer and the (meth)acrylic acid monomer are copolymerized with the terminal double bonds of the branched-chain of the conjugated diene polymer of formula (a) to obtain the copolymer (A).

Specifically, step (d) includes the following steps (d-1) to (d-3).

(d-1) The conjugated diene polymer of formula (a) is mixed into a solvent, followed by heating to a reaction temperature to prepare a reaction solution.

(d-2) An effective amount of a conjugated diene monomer, an effective amount of a (meth)acrylic acid monomer, and an initiator are mixed to obtain a monomer mixture.

(d-3) A copolymerization reaction is performed by adding the monomer mixture at a controlled rate to the reaction solution or vice versa to obtain the copolymer (A).

Preferably, the reaction temperature of step (d) ranges from 60 to 100° C.

Preferably, in step (d), the conjugated diene monomer is used in an amount ranging from 10 to 200 parts by weight, and the (meth)acrylic acid monomer is used in an amount ranging from 5 to 100 parts by weight, based on 100 parts by weight of the conjugated diene polymer of formula (a).

Preferably, the monomer mixture is added dropwise to the reaction solution over a period ranging from 5 hours to 15 hours.

Preferably, the copolymerization reaction is continued for a period ranging from 0.5 hour to 3 hours after the addition of the monomer mixture to the reaction solution is completed.

Examples of the conjugate diene monomer include, but are not limited to, 1,3-butadiene, 2-methyl-1,3-butadiene, 2,3-dimethyl-1,3-butadiene, 1,3-pentadiene, and 1,3-hexadiene. The aforesaid examples of the conjugated diene monomer can be used alone or as a mixture of two or more.

Examples of the (meth)acrylic acid monomer include, but are not limited to, methyl (meth)acrylate, ethyl (meth)acrylate, n-propyl (meth)acrylate, iso-propyl (meth)acrylate, n-butyl (meth)acrylate, iso-butyl (meth)acrylate, sec-butyl (meth)acrylate, tert-butyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, allyl (meth)acrylate, dicyclopentenyloxyethyl(meth)acrylate, dicyclopentenyl (meth)acrylate, glycidyl methacrylate, benzyl (meth)acrylate, phenyl (meth)acrylate, methoxy triethylene glycol acrylate, methoxy triethylene glycol methacrylate, lauryl methacrylate, tetradecyl methacrylate, cetylmethacrylate, octadecylmethacrylate, eicosylmethacrylate, docosylmethacrylate, N,N-dimethyl aminoethyl acrylate, N,N-dimethyl aminoethyl methacrylate, N,N-diethyl aminopropyl acrylate, N,N-dimethyl aminopropyl methacrylate, N,N-dibutyl aminopropyl acrylate, and N,t-butyl aminoethyl methacrylate. The aforesaid examples of the (meth)acrylic acid monomer can be used alone or as a mixture of two or more.

Preferably, examples of the (meth)acrylic acid monomer containing a hydroxyl group used in the aforesaid step (c) include, but are not limited to, 2-hydroxyethyl (meth)acrylate, 2-hydroxypropyl (meth)acrylate, 3-hydroxypropyl (meth)acrylate, pentaerythritol tri(meth)acrylate, and dipentaerythritol hexa(meth)acrylate. More preferably, the (meth)acrylic acid monomer containing a hydroxyl group is 2-hydroxyethyl (meth)acrylate.

Preferably, the solvents used in the aforesaid steps (a), (b), (c), and (d) are respectively selected from aliphatic or aromatic hydrocarbon compounds. More preferably, the solvents used in the aforesaid steps (a), (b), (c), and (d) are respectively selected from hexane, heptane, toluene, or xylene.

Examples of the initiator include, but are not limited to, azo compounds and peroxides. Examples of the azo compounds include, but are not limited to, 2,2′-azobis-2-methyl butyronitrile (referred to as AMBN), 2,2′-azobis(2,4-dimethylvaleronitrile (referred to as ADVN), and 2,2′-azobisisopropyl cyanide. Examples of the peroxides include, but are not limited to, benzoylperoxide.

The copolymer (A) preferably contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

When the copolymer fraction having a molecular weight ranging from 30,000 to 900,000 is less than 60 wt %, the adhesion property of the photosensitive resin composition containing the copolymer (A) is inferior. When the copolymer fraction having a molecular weight ranging from 30,000 to 900,000 is more than 99 wt %, the production cost for the photosensitive resin composition is relatively high and the adhesion property of the photosensitive resin composition can not be further enhanced.

The copolymer fraction having a molecular weight ranging from 30,000 to 900,000 is more preferably from 65 wt % to 95 wt %, and most preferably from 70 wt % to 90 wt %.

When the copolymer fraction having a molecular weight ranging from 1,000 to 10,000 is less than 1 wt %, the production cost for the photosensitive resin composition is relatively high and the impact resistance of the photosensitive resin composition can not be further enhanced. When the copolymer fraction having a molecular weight ranging from 1,000 to 10,000 is more than 22 wt %, the adhesion property and the impact resistance of the photosensitive resin composition containing the copolymer (A) are inferior.

The copolymer fraction having a molecular weight ranging from 1,000 to 10,000 is more preferably from 3 wt % to 20 wt % and most preferably from 5 wt % to 18 wt %.

### (B) A Compound Having at Least One Ethylenically Unsaturated Group:

Examples of the compound (B) include, but are not limited to, a compound having one (meth)acrylic acid group, a compound having two or more (meth)acrylic acid groups, and combinations thereof.

Examples of the compound having one (meth)acrylic acid group include, but are not limited to, acrylamide, (meth)acryloylmorpholine, 7-amino-3,7-dimethyloctyl(meth)acrylate, isobutoxymethyl(meth)acrylamide, isobornyloxyethyl(meth)acrylate, isobornyl(meth)acrylate, 2-ethylhexyl(meth)acrylate, ethyl diethylene glycol(meth)acrylate, t-octyl(meth)acrylamide, diacetone(meth)acrylamide, dimethylaminoethyl(meth)acrylate, dodecyl (meth)acrylate, dicyclopentenyloxyethyl(meth)acrylate, dicyclopentenyl(meth)acrylate, N,N-dimethyl(meth)acrylamide, tetrachlorophenyl(meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate, and bornyl (meth)acrylate.

Examples of the compound having two or more (meth)acrylic acid groups include, but are not limited to, ethylene glycol di(meth)acrylate, dicyclopentenyl di(meth)acrylate, triethylene glycol diacrylate, tetraethylene glycol di(meth)acrylate, tri(2-hydroxyethyl)isocyanate di(meth)acrylate, tri(2-hydroxyethyl)isocyanate tri(meth)acrylate, caprolactone-modified tri(2-hydroxyethyl)isocyanate tri(meth)acrylate, trimethylolpropyl tri(meth)acrylate, ethylene oxide (hereinafter abbreviated as EO) modified trimethylolpropyl tri(meth)acrylate, propylene oxide (hereinafter abbreviated as PO) modified trimethylolpropyl tri(meth)acrylate, tripropylene glycol di(meth)acrylate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritolhexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, ditrimethylolpropyl tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol triacrylate, EO-modified bisphenol F di(meth)acrylate, phenol novolac polyglycidyl ether (meth)acrylate, or the like.

Preferably, the compound having at least one ethylenically unsaturated group is selected from dicyclopentenyloxyethyl acrylate, 2-hydroxyethyl methacrylate, isobornylacrylate, isobornylmethacrylate, trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, PO-modified glycerol triacrylate, or combinations thereof.

The compound (B) is used in an amount ranging preferably from 20 to 100 parts by weight, more preferably from 30 to 90 parts by weight, and most preferably from 35 to 80 parts by weight, based on 100 parts by weight of the copolymer (A).

### (C) Photoinitiator:

Examples of the photoinitiator suitable for the present invention include, but are not limited to, acetophenone compounds, phenyl ketone compounds, biimidazole compounds, acyl oxime compounds, acylphosphine oxide compounds, or combinations thereof.

Examples of the acetophenone compounds include, but are not limited to, p-dimethylamino-acetophenone, α,α′-dimethoxyazoxy-acetophenone, 2,2′-dimethyl-2-phenyl-acetophenone, p-methoxy-acetophenone, 2-methyl-1-(4-methylthio phenyl)-2-morpholino-1-propanone, 2-benzyl-2-N,N-dimethylamino-1-(4-morpholinophenyl)-1-butanone, or the like.

Examples of the phenyl ketone compounds include, but are not limited to, 1-hydroxycyclohexyl-phenyl-ketone (trade name: Irgacure 184, manufactured by Ciba Specialty Chemicals), 2-hydroxy-2-methyl-1-phenyl-propane-1-one (trade name: DAROCUR 1173, manufactured by Ciba Specialty Chemicals), 2-hydroxy-1-{4-[4-(2-hydroxy-2-methyl-propionyl)benzyl]phenyl}-2-methyl-propane-1-one (trade name: IRGACURE 127, manufactured by Ciba Specialty Chemicals), or the like.

Examples of the biimidazole compounds include, but are not limited to, 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methyl phenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, 2,2′-bis(2,4-dichlorophenyl)-4,4′,5,5′-tetraphenyl-biimidazole, or the like.

Examples of the acyl oxime compounds include, but are not limited to, ethanone, 1-[9-ethyl-6-(2-methylbenzoyl)-9H-carbazole-3-yl]-, 1-(O-acetyl oxime) (for example, trade name: CGI-242, manufactured by Ciba Specialty Chemicals), 1-(4-phenyl-thio-phenyl)-octane-1,2-dion 2-oxime-O-benzoate (for example, trade name: CGI-124, manufactured by Ciba Specialty Chemicals), and ethanone, 1-[9-ethyl-6-(2-chloro-4-benzyl-thio-benzoyl) -9H-carbazole-3-yl]-, 1-(O-acetyl oxime) (manufactured by Adeka).

Examples of the acylphosphine oxide compounds include, but are not limited to, 2,4,6-trimethyl benzoyl diphenyl phosphine oxide (trade namne: TPO, manufactured by Ciba Specialty Chemicals), bis-(2,6-dimethoxybenzoyl)-2,4,4-trimethylbenzyl phosphine oxide, or the like.

Preferably, the photoinitiator is selected from p-dimethylamino-acetophenone, 1-hydroxycyclohexyl-phenyl-ketone, 2-hydroxy-2-methyl-1-phenyl-propane-1-one, and 2,4,6-trimethyl benzoyl diphenyl phosphine oxide.

The photoinitiator is used in an amount ranging preferably from 2 to 40 parts by weight, more preferably from 3 to 35 parts by weight, and most preferably from 5 to 30 parts by weight, based on 100 parts by weight of the compound (B).

### (D) Hydrogenated Terpene Resin:

In addition to the copolymer (A), the compound (B), and the photoinitiator, the photosensitive resin composition of the present invention includes a hydrogenated terpene resin so as to further enhance the adhesion property thereof. Examples of the hydrogenated terpene resin suitable for the present invention include, but are not limited to, Clearon P-85, ClearonM-115, Clearon M-105, Clearon P-125, Clearon P-115, and Clearon P-105 (products all commercially available from Yasuhara Chemical).

### (E) Other Additives:

Other additives, such as sensitizer, surfactant, defoaming agent, solubilizer, or the like, can be added to the photosensitive resin composition of the present invention, as necessary.

An adhesive layer can be formed between a touch unit and a liquid crystal display unit of a display device by curing the photosensitive resin composition of the present invention. Preferably, the photosensitive resin composition of the present invention is cured via irradiation using ultraviolet light, such as g-line, h-line, i-line, or the like. The devices for providing the ultraviolet light include, but are not limited to, a high pressure mercury lamp, a ultra-high pressure mercury lamp, or a metal halide lamp.

The display device of the present invention includes a touch unit, a liquid crystal display unit, and the aforesaid adhesive layer disposed between the touch unit and the liquid crystal display unit.

The adhesive layer formed between the touch unit and the liquid crystal display unit of the display deice is capable of providing improved optical properties, such as reduced scattering effect, enhanced image brightness, and improved displaying quality, in addition to high adhesion property and good impact resistance.

The following examples are provided to illustrate the preferred embodiments of the invention, and should not be construed as limiting the scope of the invention.

### EXAMPLES

### Synthesis of Conjugated Diene Polymer Having a (Meth)acryloyl Group

### Synthesis Example a

A 1000 ml four-necked flask equipped with a nitrogen inlet, a stirrer, a heater, a condenser, and a thermometer was introduced with nitrogen and was added with polyisoprene-grafted maleic anhydride (weight average molecular weight: 25,000, manufactured by Sigma-Aldrich, 100 parts by weight), 2-hydroxyethyl (meth)acrylate (0.04 part by weight), hydroquinone (0.05 part by weight), N,N-dimethylbenzylamine (0.3 part by weight), and n-heptane (20 parts by weight, as a solvent). A polymerization reaction was conducted for 3 hours at a temperature of 80° C. After the polymerization reaction was completed, the product thus obtained was taken out of the flask, followed by devolatilizing the solvent, thereby obtaining a conjugated diene polymer having a (meth)acryloyl group of the aforesaid formula (a).

### Synthesis of Copolymer A

### Synthesis Example A-1

A 2000 ml autoclave was introduced with nitrogen and was added with the conjugated diene polymer obtained in Synthesis Example a (50 parts by weight) and toluene (200 parts by weight, as a solvent) to obtain a solution of the conjugated diene polymer totally dissolved in toluene. The temperature of the solution was adjusted to 80° C.

Butadiene (hereinafter abbreviated as BD, 40 parts by weight), dicyclopentenyloxyethyl acrylate (hereinafter referred to as FA-512A, 10 parts by weight), and 2,2′-Azobis-2-methyl butyronitrile (a polymerization initiator, hereinafter abbreviated as AMBN, 2 parts by weight) dissolved in toluene (10 parts by weight) were mixed to obtain a mixture, which was added dropwise to the solution in the autoclave maintained at a temperature of 80° C. over a period of 6 hours.

After the addition of BD, FA-512A, and AMBN was completed, the polymerization reaction was conducted for a further one hour at 80° C. in the autoclave. The product thus obtained was taken out of the autoclave, followed by devolatilizing the solvent, thereby obtaining a copolymer A-1.

### Synthesis Examples A-2 to A-7

Synthesis Examples A-2 to A-7 were conducted in a manner identical to that of Synthesis Example 1 using the components and the amounts thereof and polymerization conditions shown in Table 1 so as to obtain copolymers A-2 to A-7.

### Synthesis Example A-8

100 parts by weight of the copolymer obtained in Synthesis Example A-7 was added into a co-solvent composed of methanol (700 parts by weight) and toluene (300 parts by weight), followed by stirring for 30 minutes. Precipitate formed thereby was taken out of the reactor, followed by devolatilizing the solvent, thereby obtaining a copolymer A-8.

### Synthesis Examples A-9 to A-10

Synthesis Examples A-9 and A-10 were conducted in a manner identical to that of Synthesis Example 1 using the components, the amounts and the addition manner of the components, and polymerization conditions shown in Table 1 so as to obtain copolymers A-9 and A-10.

### Synthesis Example A-11

100 parts by weight of the copolymer obtained in Synthesis Example A-10 was added into a co-solvent of composed of acetone (800 parts by weight) and toluene (200 parts by weight), followed by stirring for 30 minutes. Precipitate formed thereby was taken out of the reactor, followed by devolatilizing the solvent, thereby obtaining a copolymer A-11.

TABLE 1

| | Parts by weight | | | | | | | | | | | | | | | |
|---|---|---|---|---|---|---|---|---|---|---|---|---|---|---|---|---|
| | | conjugated | | | | | | | | | | | | | | |
| | | diene | | | | | | | | | | | Monomer | | | |
| Syn. | | monomers | | | (meth)acrylic acid monomers | | | | | initiators | | solvent | addition | Temp | Time (hr) | |
| Exs. | Polymer¹ | BD | IP | PD | MMA | GMA | FA-512A | FA-512M | HEMA | AMBN | ADVN | toluene | manner | (° C.) | T1² | T2³ |
| A-1 | 50 | 40 | | | | | 10 | | | 2 | | 200 | Dropwise | 80 | 6 | 1 |
| A-2 | 50 | | 35 | | | 2 | | 10 | 3 | 2 | | 200 | Dropwise | 100 | 6 | 1 |
| A-3 | 50 | | | 30 | 5 | | 5 | 5 | 5 | 1 | 1 | 200 | Dropwise | 90 | 6 | 1 |
| A-4 | 60 | 30 | | | 2 | 3 | 5 | | | 2 | | 200 | Dropwise | 80 | 10 | 1 |
| A-5 | 40 | 40 | 10 | | | | 5 | | 5 | | 2 | 200 | Dropwise | 80 | 12 | 2 |
| A-6 | 40 | 30 | 10 | 10 | | | | 6 | 4 | 3 | | 200 | Dropwise | 80 | 8 | 1 |
| A-7 | 50 | 40 | | | | | 8 | | 2 | 2 | 3 | 200 | Dropwise | 60 | 6 | 1 |
| A-8 | Treating A-7 with a co-solvent of methanol and toluene | | | | | | | | | | | | | | | |
| A-9 | 50 | 40 | | | | | 5 | 5 | | 2 | | 200 | Dropwise | 80 | 4 | 0.5 |
| A-10 | 50 | 40 | | | | 2 | 4 | | 4 | 2 | | 300 | Single | 80 | — | 7 |
| | | | | | | | | | | | | | Addition | | | |

| | |
|---|---|
| A-11 | Treating A-10 with a co-solvent of acetone and toluene |

¹Conjugated diene polymer having a (meth)acryloyl group
²A period for adding the monomers and the initiators
³A subsequent reaction period after the addition of the monomers and the initiator was completed
BD: butadiene
IP: isoprene
PD: 1,3-pentadiene
MMA: methyl methacrylate
GMA: glycidyl methacrylate
FA-512A: dicyclopentenyloxyethyl acrylate
FA-512M: dicyclopentenyloxyethyl methacrylate
HEMA: 2-hydroxyethyl methacryalte
AMBN: 2,2′-azobis-2-methyl butyronitrile
ADVN: 2,2′-azobis(2,4-dimethylvaleronitrile)

### Preparation of Photosensitive Resin Compositions

### Example 1

Copolymer A-1 (100 parts by weight) dicyclopentenyloxyethyl acrylate (hereinafter referred to as B-1, 45 parts by weight), and 2,4,6-trimethyl benzoyl diphenyl phosphine oxide (hereinafter referred to as C-1, parts by weight) were mixed together to obtain a photosensitive resin composition. The photosensitive resin composition thus obtained was evaluated according to the following evaluation methods. The evaluation results are shown in Table 2.

### Examples 2 to 7 and Comparative Examples 1 to 4

Examples 2 to 7 and Comparative Examples 1 to 4 were conducted in a manner identical to that of Example 1 using the components and the amounts thereof shown in Table 2. The obtained photosensitive resin compositions of Examples 2 to 7 and Comparative Examples 1 to 4 were evaluated according to the following evaluation methods. The evaluation results are shown in Table 2.

### Comparative Example 5

Comparative Example 5 was conducted in a manner identical to that of Example 1 except that copolymer A-1 was replaced with the conjugated diene polymer obtained in Synthesis Example a. The photosensitive resin composition thus obtained was evaluated according to the following evaluation methods. The evaluation results are shown in Table 2.

### Evaluation Methods:

### 1. Molecular Weight Distribution of the Copolymer (A):

The molecular weight distribution of the copolymer was determined by gel permeation chromatography (referred to as GPC) under the following conditions. An integral molecular weight distribution curve was obtained by plotting cumulative weight percentage versus molecular weight falling within a range between 1,000 and 1,000,000. The weight percentages of a copolymer fraction having a molecular weight ranging from 30,000 to 900,000 and a copolymer fraction having a molecular weight ranging from 1,000 to 10,000 were calculated from the integral molecular weight distribution curve.

### Measurement Conditions for the GPC:

Apparatus: 717 plus (manufactured by Waters)
Columns: 79911GP-501, 79911GP-502, 79911GP-503, and 79911GP-504 (manufactured by Agilent Technologies)
Detector: 2414 RI Detector (manufactured by Waters)
Mobile Phase: tetrahydrofuran
Flow Rate: 1.0 ml/min
Injection Volume: 100 μl
Measurement Temperature: 40° C.
Measurement Period: 60 minutes
Molecular Weight Standard: polystyrene

### 2. Adhesion:

A photosensitive resin composition is applied and sandwiched between two glass plates (each is 20 mm×50 mm), and is irradiated using ultraviolet light (illumination intensity: 100 mW/cm², exposure time: 50 sec) to form a cured adhesive layer (thickness: 0.1 mm) for adhering the glass plates together. The glass plates are subjected to pulling using a jig of a tensile tester (Model No. AI-7000S; manufactured by GOTECH) until the glass plates are separated from each other. The contact area of the jig with the glass plates is 4 mm², and the pulling velocity is 5 mm/sec. The maximum pulling force is recorded.

⊚: maximum pulling force≧70 N

◯: 70 N>maximum pulling force≧50 N

Δ: 50 N>maximum pulling force≧30 N

X: maximum pulling force<30 N

### 3. Impact Resistance:

A photosensitive resin composition is applied and sandwiched between two glass plates (each is 20 mm×50 mm), and is irradiated using ultraviolet light (illumination intensity: 100 mW/cm², exposure time: 50 sec) to form a cured adhesive layer (thickness: 0.1 mm) for adhering the glass plates together. The glass plates are pressed using a jig of a tensile tester (Model No. AI-7000S; manufactured by GOTECH) until the glass plates break. The diameter of the contact area of the jig with the glass plates is 3 mm, and the pressing velocity is 1 mm/sec. The maximum pressing force is recorded.

◯: maximum pressing force≧30 N

Δ: 30 N>maximum pressing force≧20 N

X: maximum pulling force<20 N

TABLE 2

| | | Examples | | | | | | | Comp. Exs. | | | | |
|---|---|---|---|---|---|---|---|---|---|---|---|---|---|
| Components | | 1 | 2 | 3 | 4 | 5 | 6 | 7 | 1 | 2 | 3 | 4 | 5 |
| Conjugated diene polymer obtained in Syn. Ex. a | | | | | | | | | | | | | 100 |
| Copolymers (A) obtained by | A-1 | 100 | | | | | | | | | | | |
| subjecting a conjugated diene | A-2 | | 100 | | | | | | | | | | |
| polymerhavinga(meth)acryloyl | A-3 | | | 100 | | | | | | | | | |
| group, a conjugated diene | A-4 | | | | 100 | | | | | | | | |
| monomer, and a (meth)acrylic | A-5 | | | | | 100 | | | | | | | |
| acid monomer to | A-6 | | | | | | 100 | | | | | | |
| copolymerization | A-7 | | | | | | | | 100 | | | | |
| (Parts by weight) | A-8 | | | | | | | 100 | | | | | |
| | A-9 | | | | | | | | | 100 | | | |
| | A-10 | | | | | | | | | | 100 | | |
| | A-11 | | | | | | | | | | | 100 | |
| Compounds having at least one | B-1 | 45 | | 30 | 20 | 15 | 10 | 20 | 45 | 45 | 45 | 45 | 45 |
| ethylenically unsaturated | B-2 | | 30 | | 20 | 15 | 5 | 10 | | | | | |
| group (B) | B-3 | | 30 | | | 20 | 5 | | | | | | |
| (Parts by weight) | B-4 | | 40 | | | | | 10 | | | | | |
| Photoinitiators (C) | C-1 | 10 | 20 | | 10 | 14 | 3 | 6 | 10 | 10 | 10 | 10 | 10 |
| (Parts by weight) | C-2 | | 20 | 8 | | | | | | | | | |
| Hydrogenated terpene resin (D) | D-1 | | | 80 | 100 | | | | | | | | |
| (Parts by weight) | | | | | | | | | | | | | |
| Molecular weight distribution | 30,000~900,000 | 70 | 62 | 66 | 83 | 90 | 72 | 65 | 61 | 58 | 55 | 58 | 30 |
| (%) | 1,000~10,000 | 18 | 22 | 20 | 12 | 5 | 16 | 19 | 24 | 26 | 35 | 20 | 40 |
| Evaluation | Adhesion | ◯ | ◯ | ⊚ | ⊚ | ◯ | ◯ | ◯ | Δ | X | X | X | X |
| | Impact resistance | ◯ | ◯ | ◯ | ◯ | ◯ | ◯ | ◯ | X | X | X | ◯ | X |

B-1: FA-512A, dicyclopentenyloxyethyl acrylate
B-2: 2-hydroxyethyl methacrylate
B-3: isobornyl acrylate
B-4: isobornyl methacrylate
C-1: DAROCUR TPO, 2,4,6-trimethyl benzoyl diphenyl phosphine oxide
C-2: IRGACURE 184, 1-Hydroxy-cyclohexyl-phenyl-ketone
D-1: Clearon P-85, manufactured by Yasuhara Chemical

As shown in Tables 1 and 2, the copolymer A-7 contained in the photo-sensitive resin composition of Comparative Example 1 contains 61 wt % of a copolymer fraction having a molecular weight ranging from 30,000 to 900,000 and 24 wt % of a copolymer fraction having a molecular weight ranging from 1,000 to 10,000. In Synthesis Example A-7, the reaction temperature for manufacturing the copolymer A-7 is only 60° C. Both the adhesion and impact resistance of the photo-sensitive resin composition of Comparative Example 1 are insufficient.

The copolymer A-9 contained in the photo-sensitive resin composition of Comparative Example 2 contains 58 wt % of a copolymer fraction having a molecular weight ranging from 30,000 to 900,000 and 26 wt % of a copolymer fraction having a molecular weight ranging from 1,000 to 10,000. In Synthesis Example A-9, although the monomers for manufacturing the copolymer A-9 are added dropwise, the period for adding the monomers and the initiator is only 4 hours. Both the adhesion and impact resistance of the photo-sensitive resin composition of Comparative Example 2 are insufficient.

The copolymer A-10 contained in the photo-sensitive resin composition of Comparative Example 3 contains 55 wt % of a copolymer fraction having a molecular weight ranging from 30,000 to 900,000 and 35 wt % of a copolymer fraction having a molecular weight ranging from 1,000 to 10,000. In Synthesis Example A-10, the monomers for manufacturing the copolymer A-10 are added at one time (i.e., in a manner of single addition). Both the adhesion and impact resistance of the photo-sensitive resin composition of Comparative Example 3 are insufficient.

The copolymer A-11 contained in the photo-sensitive resin composition of Comparative Example 4 contains 58 wt % of a copolymer fraction having a molecular weight ranging from 30,000 to 900,000 and 20 wt % of a copolymer fraction having a molecular weight ranging from 1,000 to 10,000. In Synthesis Example A-11, the monomers for manufacturing the copolymer A-11 are added at one time and the copolymer A-11 was obtained by treating the copolymer A-10 with a co-solvent of acetone and toluene. Both the adhesion and impact resistance of the photo-sensitive resin composition of Comparative Example 4 are insufficient.

In Comparative Example 5, the conjugated diene polymer obtained in Synthesis Example a was used for manufacturing the photosensitive resin composition, and contains 30 wt % of a copolymer fraction having a molecular weight ranging from 30,000 to 900,000 and 40 wt % of a copolymer fraction having a molecular weight ranging from 1,000 to 10,000. Both the adhesion and impact resistance of the photo-sensitive resin composition of Comparative Example 5 are insufficient.

In Examples 1-7, all of the copolymers contained in the photo-sensitive resin compositions contain 60 wt % to 99 wt % of a copolymer fraction having a molecular weight ranging from 30,000 to 900,000, and 1 wt % to 22 wt % of a copolymer fraction having a molecular weight ranging from 1,000 to 10,000. In synthesis examples for manufacturing the copolymers used for Examples 1-7, the amounts of the components for the copolymers, the reaction conditions, such as the addition manner of the monomers, the reaction temperature, the period for adding the monomers and the initiator, and the subsequent reaction period are specifically controlled. Both the adhesion and impact resistance of the photo-sensitive resin compositions of Examples 1-7 are enhanced.

Therefore, it has been demonstrated that improved adhesion property and impact resistance can be obtained by the photosensitive resin composition of the present invention in which the molecular weight distribution of the copolymer A is specifically controlled.

In view of the aforesaid, the present invention provides a photosensitive resin composition having good adhesion property and impact resistance, and an adhesive layer made from the photosensitive resin composition via curing using, for example, ultraviolet light. The adhesive layer can be used for adhering a touch unit and a liquid crystal display unit in a display device.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A photosensitive resin composition, comprising:
a copolymer obtained by subjecting a conjugated diene polymer having a (meth)acryloyl group, a conjugated diene monomer, and a (meth)acrylic acid monomer to copolymerization;
a compound having at least one ethylenically unsaturated group; and
a photoinitiator,
wherein said copolymer contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

2. The photosensitive resin composition as claimed in claim 1, wherein said copolymer fraction having a molecular weight ranging from 30,000 to 900,000 is from 65 wt % to 95 wt %.

3. The photosensitive resin composition as claimed in claim 2, wherein said copolymer fraction having a molecular weight ranging from 30,000 to 900,000 is from 70 wt % to 90 wt %.

4. The photosensitive resin composition as claimed in claim 1, wherein said compound having at least one ethylenically unsaturated group is in an amount ranging from 20 to 100 parts by weight based on 100 parts by weight of said copolymer.

5. The photosensitive resin composition as claimed in claim 1, further comprising a hydrogenated terpene resin.

6. An adhesive layer obtained by curing the photosensitive resin composition as claimed in claim 1.

7. A display device, comprising a touch unit, a liquid crystal display unit, and the adhesive layer as claimed in claim 6 and disposed between said touch unit and said liquid crystal display unit.

8. A process for producing a copolymer for a photosensitive resin composition, comprising a step of:
subjecting a conjugated diene polymer having a (meth)acryloyl group, a conjugated diene monomer, and a (meth)acrylic acid monomer to copolymerization so that the copolymer thus produced contains 60 wt % to 99 wt % of a copolymer fraction having a molecular weight ranging from 30,000 to 900,000, and 1 wt % to 22 wt % of a copolymer fraction having a molecular weight ranging from 1,000 to 10,000 when calculated from an integral molecular weight distribution curve obtained by plotting cumulative weight percentage versus molecular weight falling within a range between 1,000 and 1,000,000 measured by gel permeation chromatography.

9. The process as claimed in claim 8, wherein the conjugated diene monomer and the (meth)acrylic acid monomer are added at a controlled rate to the conjugated diene polymer having a (meth)acryloyl group.

10. The process as claimed in claim 9, wherein the conjugated diene monomer and the (meth)acrylic acid monomer are added dropwise to the conjugated diene polymer having a (meth)acryloyl group.

11. The process as claimed in claim 9, wherein an initiator is further added at a controlled rate to the conjugated diene polymer having a (meth)acryloyl group.

12. The process as claimed in claim 11, wherein the initiator is added dropwise to the conjugated diene polymer having a (meth)acryloyl group.

13. The process as claimed in claim 12, wherein the conjugated diene monomer, the (meth)acrylic acid monomer, and the initiator are added over a period ranging from 5 hours to 15 hours.

14. The process as claimed in claim 13, wherein the copolymerization is continued for a period ranging from 0.5 hour to 3 hours after the addition of the conjugated diene monomer, the (meth)acrylic acid monomer, and the initiator is completed.

15. The process as claimed in claim 8, wherein the copolymerization is conducted at a temperature ranging from 60° C. to 100° C.

16. The process as claimed in claim 8, wherein the conjugated diene monomer is used in an amount ranging from 10 to 200 parts by weight and the (meth)acrylic acid monomer is used in an amount ranging from 5 to 100 parts by weight, based on 100 parts by weight of the conjugated diene polymer having a (meth)acryloyl group.

17. The process as claimed in claim 11, wherein the initiator is used in an amount ranging from 1 to 10 parts by weight based on 100 parts by weight of the conjugated diene polymer having a (meth)acryloyl group.
